(19) United States
(12) Patent Application Publication
(10) Pub. No.: US 2014/0294079 A1
(43) Pub. Date: Oct. 2, 2014

(54) MOTION VECTOR PROCESSING DEVICE FOR CLUSTERING MOTION VECTORS AND METHOD OF PROCESSING THE SAME

(71) Applicant: SAMSUNG ELECTRONICS CO., LTD., SUWON-SI (KR)

(72) Inventor: OMRY SENDIK, TEL-AVIV (IL)

(73) Assignee: SAMSUNG ELECTRONICS CO., LTD., SUWON-SI (KR)

(21) Appl. No.: 14/202,925

(22) Filed: Mar. 10, 2014

(30) Foreign Application Priority Data
Mar. 26, 2013 (KR) 10-2013-0032235

(51) Int. Cl. H04N 19/547

(52) U.S. Cl. CPC H04N 19/00636
USPC 375/240.16

(57) ABSTRACT

A motion vector processing device includes a motion vector detection unit, a transforming unit, and a clustering processing unit. The motion vector detection unit detects motion vectors from a current image frame and a reference image frame. The transforming unit transforms the detected motion vectors into corresponding points in a detection space. The clustering processing unit clusters the corresponding points in at least one cluster each having a bandwidth. The clustering processing unit analyzes a relation between a bandwidth of each of at least one cluster and a total number of clusters of the at least one cluster.

### CROSS-REFERENCE TO RELATED APPLICATIONS

This application claims priority under 35 U.S.C. §119 to Korean Patent Application No. 10-2013-0032235, filed on Mar. 26, 2013, in the Korean Intellectual Property Office, the disclosure of which is herein incorporated by reference in its entirety.

### TECHNICAL FIELD

The present inventive concept relates to motion vector processing devices and methods of processing the same, and more particularly, to a motion vector processing device for clustering motion vectors and a method of processing the same.

### DISCUSSION OF THE RELATED ART

To perform computer vision based applications or to process digital video, it may be necessary to analyze motion information from a video signal. The analysis of the motion information may be performed by extracting and filtering a motion vector between sequential image frames. The motion vectors describing how much each part of an image frame moves are used to estimate the motion between sequential image frames. However, some motion vectors, called outlier vectors, may describe a motion of a local object in an image frame or may describe a different motion from what most of other motion vectors describe, and may thus be removed in processing.

### SUMMARY

According to an embodiment of the present inventive concept, a motion vector processing device is provided. The motion vector processing device includes a motion vector detection unit, a transforming unit, and a clustering processing unit. The motion vector detection unit is configured to detect motion vectors from a current image frame and a reference image frame. The transformation unit is configured to transform the detected motion vectors into corresponding points in a detection space. The clustering processing unit is configured to cluster the corresponding points in at least one cluster each having a bandwidth. The clustering processing unit is configured to analyze a correlation between the bandwidth of each of the at least one cluster and a total number of clusters of the at least one cluster.

The clustering processing unit may further configured to calculate, by using the analyzed correlation, a value of the bandwidth equal to a total number of clusters of the at least one cluster, to determine the value of the bandwidth as a target bandwidth, and to cluster the corresponding points by using the target bandwidth.

The transforming unit may use a prediction method such as by using a Kalman filter.

The detection space may have at least two dimensions.

The clustering processing unit may use a Mean-Shift algorithm.

The cluster may have a circular shape.

The clustering processing unit may use a mathematical formula, Nc=(Np−1)/{(b·BW)ⁿ+1}+1, to analyze the correlation, wherein BW is the bandwidth of each of the at least one cluster, Nc is the total number of clusters of the at least one cluster, Np is a total number of clustered corresponding points, and b, n represent arbitrary real numbers.

The clustering processing unit may use a Linear Least Square to analyze the correlation.

According to an embodiment of the present inventive concept, a method of processing a motion vector is provided. The method includes detecting motion vectors from a current image frame and a reference image frame, transforming the detected motion vectors into corresponding points in a detection space, and clustering the corresponding points in at least one cluster each having a bandwidth. The step of clustering the corresponding points in at least one cluster includes analyzing a correlation between the bandwidth of each of the at least one cluster and a total number of clusters of the at least one cluster. The step of clustering the corresponding points in at least one cluster may further include calculating, by using the analyzed correlation, a value of the bandwidth equal to a total number of clusters of the at least one cluster, determining the value of the bandwidth as a target bandwidth, and clustering the corresponding points by using the target bandwidth.

The step of transforming the respective motion vectors into corresponding points in a detection space may be performed by using a prediction method such as a Kalman filter.

The detection space may have at least two dimensions.

The step of clustering the corresponding points in at least one cluster may be performed by using a Mean-Shift algorithm.

The cluster may have a circular shape.

The step of analyzing the correlation may be performed by a mathematical formula, Nc=(Np−1)/{(b·BW)ⁿ+1}+1, wherein BW is the bandwidth of each of the at least one cluster, Nc is a total number of clusters of the at least one cluster, Np is a total number of clustered corresponding points, and b, n represent arbitrary real numbers.

The step of analyzing the correlation may be performed by using a Linear Least Squares estimation.

According to an embodiment of the present inventive concept, a video encoding device is provided. The video encoding device includes a motion estimator and a motion compensation unit. The motion estimator is configured to receive a reference frame and a current frame, to detect motion vectors, and to cluster the detected motion vectors. The motion estimator includes the motion vector processing unit. The motion compensating unit is configured to perform a motion compensation on the reference frame by using the motion vectors transferred from the motion estimator. The motion vector processing unit includes a motion vector detection unit, a transforming unit, and a clustering processing unit. The motion vector detection unit is configured to detect motion vectors from a current image frame and a reference image frame. The transformation unit is configured to transform the detected motion vectors into corresponding points in a detection space. The clustering processing unit is configured to cluster the corresponding points in at least one cluster each having a target bandwidth. The clustering processing unit is configured to analyze a correlation between the bandwidth of each of the at least one cluster and a total number of clusters of the at least one cluster.

The video encoding device may further include a mode selector, a subtractor, a discrete cosine transforming unit, and a quantizer. The mode selector may be configured to select a mode for operating the video encoding device from among an inter prediction mode and an intra prediction mode. The subtractor may be configured to receive the output of the motion compensation unit and the current frame, and to generate a differential frame between the output of the motion compensation unit and the current frame. The discrete cosine transforming unit may be configured to perform a discrete cosine transformation to the differential frame and to generate a discrete cosine transforming coefficient. The quantizer may be configured to quantize the discrete cosine transforming coefficient.

The video encoding device may further include an entropy encoding unit, an inverse quantizer, and an inverse discrete cosine transforming unit. The entropy encoding unit may be configured to encode the quantized discrete cosine transforming coefficient and to generate an encoded output. The inverse quantizer may be configured to perform an inverse quantization for the output of the quantizer. The inverse discrete cosine transforming unit may be configured to perform an inverse discrete cosine transformation for the output of the inverse quantizer.

The video encoding device may further include an intra prediction processing unit, an adder. The intra prediction processing unit may be configured to receive the output of the inverse discrete cosine transforming unit through an adder and the current frame, and to generate an output. The adder may be configured to receive the output of the intra prediction processing unit, and to provide an added result of the output of the intra prediction processing unit and the output of the inverse discrete cosine transforming unit as an input to the intra prediction processing unit.

### BRIEF DESCRIPTION OF THE FIGURES

FIG. 1 is a block diagram illustrating a motion vector processing device in accordance with an embodiment of the present inventive concept;

FIG. 2 shows motion vectors detected by a motion vector detection unit of FIG. 1;

FIG. 3 is a drawing illustrating a clustering method using a Mean-Shift algorithm;

FIGS. 4 and 5 are drawings illustrating a process for calculating a correlation between a bandwidth of a cluster and the number of clusters;

FIG. 6 is a flow chart illustrating a method of processing a motion vector in accordance with an embodiment of the present inventive concept;

FIGS. 7 to 10 show an example in which a method of processing a motion vector in accordance with an embodiment of the present inventive concept is used;

FIGS. 11 to 14 show another example in which a method of processing a motion vector in accordance with an embodiment of the present inventive concept is used; and

FIG. 15 is a block diagram illustrating a video encoding device in accordance with an embodiment of the present inventive concept;

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers may refer to like elements throughout the specification.

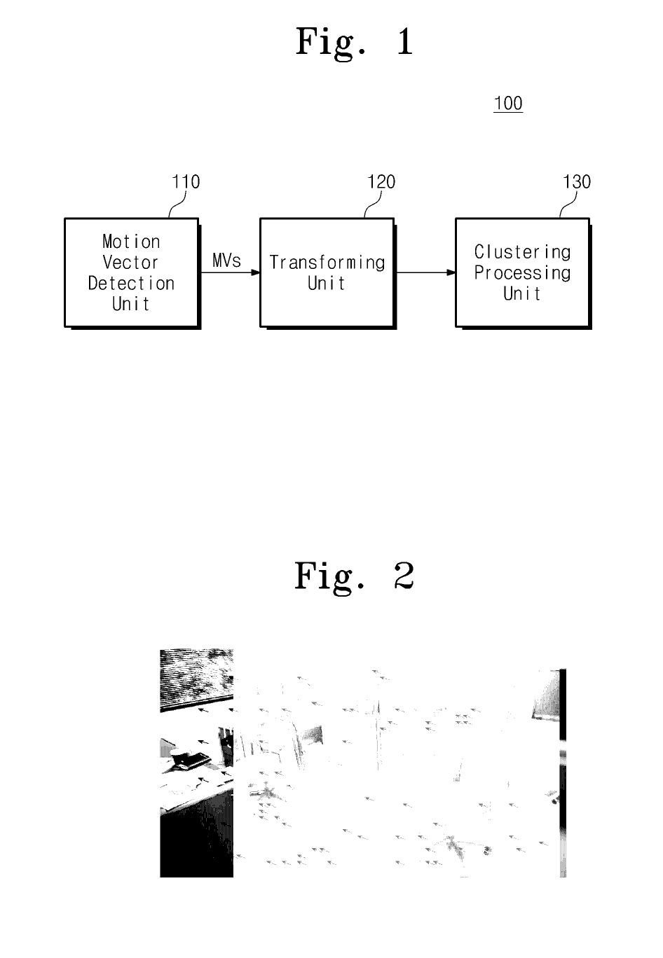

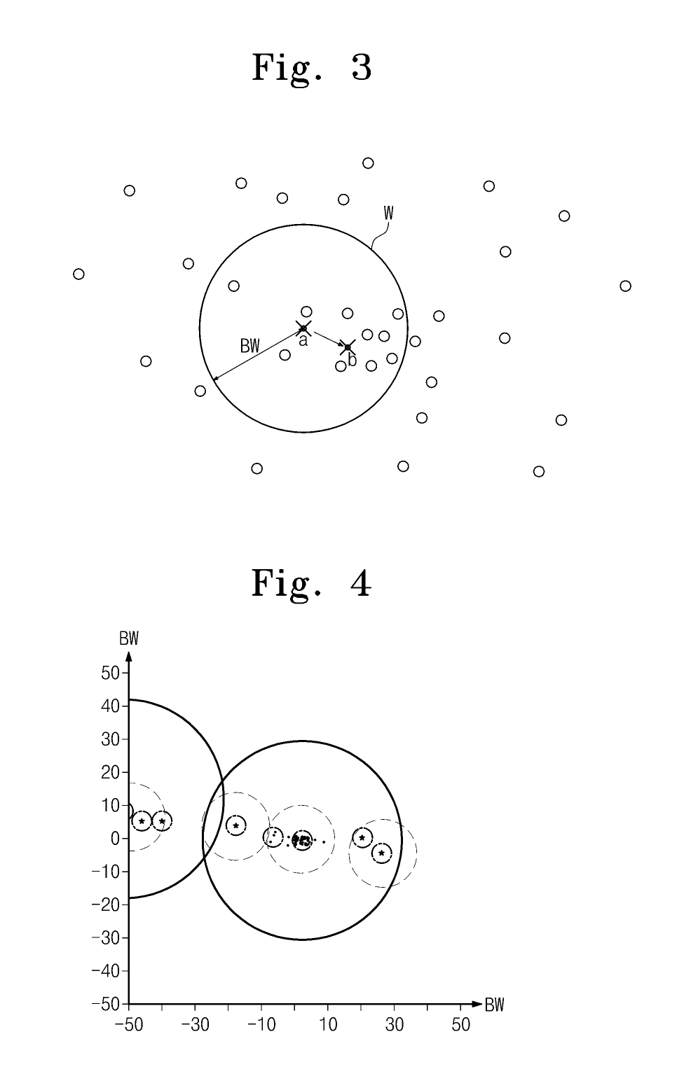

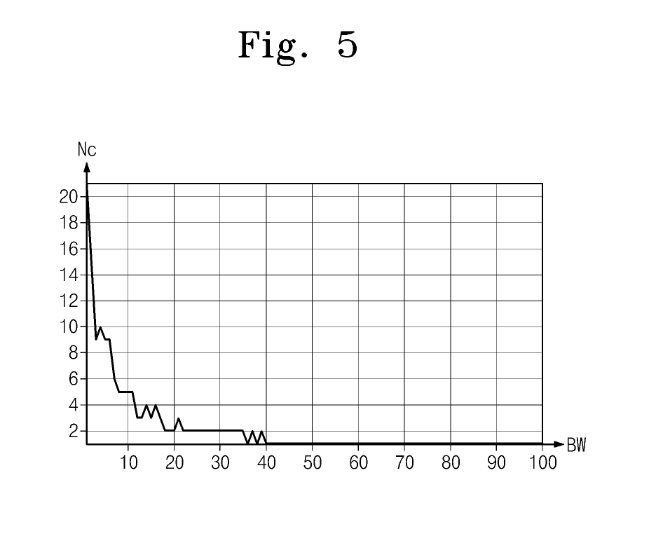

FIG. 1 is a block diagram illustrating a motion vector processing device in accordance with an embodiment of the present inventive concept. FIG. 2 shows motion vectors detected by a motion vector detection unit 110 of FIG. 1. FIG. 3 is a drawing illustrating a clustering method using a Mean-Shift algorithm. FIGS. 4 and 5 are drawings illustrating a process for calculating a correlation between the number of clusters and a bandwidth of a cluster.

Referring to FIG. 1, a motion vector processing device 100 may include a motion vector detection unit 110, a transforming unit 120 and a clustering processing unit 130.

The motion vector detection unit 110 may sequentially receive image frames at a time. The motion vector detection unit 110 may detect a motion vector between the sequentially received image frames. A motion vector may include information about a motion of an object which appears in the image frames. The motion vector detection unit 110 may detect a motion vector using a block matching algorithm. However, the method for detecting a motion vector is not limited thereto.

Referring to FIG. 2, the motion vectors may include information about a motion of objects between a reference image frame and a current image frame. Directions of the respective motion vectors may reflect directions in which the objects move. Lengths of the motion vectors may reflect distances that the objects move.

Referring to FIG. 2, for example, a first group of the motion vectors (for example, see black colored motion vector arrows) having similar directions and lengths may have similar distances and directions of movement. A second group of the motion vectors (for example, see white colored motion vector arrows) having different directions and lengths may have different distances and directions of movement from those from the first group of the motion vectors. Since most of the motion vectors belong to the first group of the motion vectors, the second group of the motion vectors may be regard as outlier vectors and removed through a clustering process.

Referring back to FIG. 1, the transforming unit 120 may receive the detected motion vectors and transform the detected motion vectors into corresponding points in a detection space. The transforming unit 120 may use a prediction method such as by using a Kalman Filter to transform the detected motion vectors into the corresponding points. The detection space may have n dimensions, where n is a positive number.

The clustering processing unit 130 may cluster the corresponding points. In one aspect, the clustering may be a process of gathering the corresponding points. The clustering processing unit 130 may use a Mean-Shift algorithm to cluster the corresponding points. The Mean-Shift algorithm is an algorithm tracing an interesting area of an object based on a density distribution of data set. The Mean-Shift algorithm will be described below with reference to FIG. 3.

Referring to FIG. 3, the Mean-Shift algorithm may cluster the corresponding points in at least one cluster each having a bandwidth. The Mean-Shift algorithm may define a window (W) having a bandwidth (BW) The Mean-Shift algorithm may define a first window having a bandwidth around the corresponding points, calculate a first average among the corresponding points included in the defined first window, and move a center of the first window to the calculated first average. The Mean-Shift algorithm may define a second window having the bandwidth around the corresponding points, calculate the second average among the corresponding points included in the defined second window, and move a center of the second window to the calculated second average. The processes above is repeated until a center of a window converges. These process are illustrated in FIG. 3 moves from a to b.

Referring back to FIG. 1, the clustering processing unit 130 may cluster the corresponding points in at least one cluster each having a bandwidth. A size of the at least one cluster may be defined by a bandwidth. The at least one cluster may have a circular shape and the bandwidth may be represented as a radius of the circle.

The clustering processing unit 130 may calculate a bandwidth of each of the at least one cluster. The clustering processing unit 130 may calculate a correlation between a bandwidth of each of the at least one cluster and a total number (Nc) of clusters of the at least one cluster.

Referring to FIG. 4, as a result of the clustering, there are clusters having different bandwidths (e.g., 3, 10, 30) (BW). When the bandwidth (BW) is 3, the number (Nc) of clusters may be about eight. If the bandwidth (BW) is 10, the number (Nc) of clusters may be about 4. If the bandwidth (BW) is 30, the number (Nc) of clusters may be about two. As the bandwidth (BW) increases, the number (Nc) of clusters may decrease.

When clustering the corresponding points using the Mean-Shift algorithm, a selected value of the bandwidth (BW) is important. This is because the selected value of the bandwidth (BW) affects the number (Nc) of clusters. For example, when an excessively large value of the bandwidth (BW) is selected, clusters that should be separated may be merged and a wrong clustering result may be generated. When a small value of the bandwidth (BW) is selected, too many clusters may be generated.

Referring to FIG. 5, a correlation between a bandwidth (BW) of each of the at least one cluster and a total number (Nc) of clusters of the at least one cluster is illustrated. As described above, as the bandwidth (BW) increases, the number (Nc) of clusters decreases.

Referring back to FIG. 1, the clustering processing unit 130 may use a mathematical formula 1 to calculate the correlation between the bandwidth (BW) of each of the at least one cluster and a total number (Nc) of clusters of the at least one cluster. However, the method for calculating the correlation between the bandwidth (BW) of each of the at least one cluster and a total number (Nc) of clusters of the at least one cluster to the mathematical formula 1.

$${N}_{C} = \frac{{N}_{P} - 1}{{( b \cdot BW )}^{n} + 1} + 1 \qquad [ mathematical formula 1 ]$$

Here, Nc is the number of clusters, Np is the number of clustered corresponding points, BW is a bandwidth (BW) of each of the at least one cluster, and b, n represent an arbitrary real number. A value of Np may be determined in advance.

The clustering processing unit 130 may use a Linear Least Square to fit the calculated mathematical formula 1 to the graph illustrated in FIG. 5. To use the Linear Least Squares, the mathematical formula 1 may be transformed into a mathematical formula 2.

$${log}_{10} ( \frac{{N}_{P} - 1}{{N}_{C} - 1} - 1 ) = n {log}_{10} b + n {log}_{10} BW \qquad [ mathematical formula 2 ]$$

The mathematical formula 2 may be given by taking the log of both sides of the mathematical formula 1. An amount of error (ε) caused by applying the Linear

Least Squares may be represented as a mathematical formula 3.

$$ɛ = {\sum }_{i}^{ } {( {\begin{matrix}{log}_{10} ( \frac{{N}_{P} - 1}{{N}_{C} - 1} - 1 ) - \\ n {log}_{10} b - n {log}_{10} BW\end{matrix}}_{i} )}^{2} \qquad [ mathematical formula 3 ]$$

To consider various numbers (Nc) of clusters minimizing an error (c), the mathematical formula 3 may be transformed into a mathematical formula 4.

$$ɛ = {\sum }_{i}^{ } {( \begin{matrix}{N}_{C} {log}_{10} ( \frac{{N}_{P} - 1}{{N}_{C} - 1} ) - {N}_{C} n {log}_{10} b - \\ {N}_{C} n {log}_{10} {BW}_{i}\end{matrix} )}^{2} \qquad [ mathematical formula 4 ]$$

Here, b and n may be calculated through the mathematical formula 4.

The clustering processing unit 130 may calculate a value of the bandwidth (e.g., a target bandwidth (BW_{target})) which is equal to a total the number (Nc) of clusters of the at least one cluster, by using the mathematical formula 1. The clustering processing unit 130 may determine the value of the bandwidth as a target bandwidth (BW_{target}). A mathematical formula 5 may be given by replacing Nc by BW from the mathematical formula 1.

$$BW = \frac{{N}_{P} - 1}{{( b \cdot BW )}^{n} + 1} + 1 \qquad [ mathematical formula 5 ]$$

The mathematical formula 5 may be transformed into a mathematical formula 6 to calculate a target bandwidth (BW_{target}).

$$y = \frac{{N}_{P} - 1}{{( b \cdot BW )}^{n} + 1} + 1 - BW \qquad [ mathematical formula 6 ]$$

The values of Np, b, and n may be determined in advance. The clustering processing unit 130 may calculate a target bandwidth (BW_{target} 1 through the following steps as below.

In a first step, a target bandwidth (BW_{target}) is i assumed to be an arbitrary value (X) and a value of yᵢ is calculated by using the mathematical formula 6. In a second step, if the value of yᵢ is greater than 0, a correction value (a) may be subtracted from the arbitrary value (X) and if the value of yᵢ is smaller than 0, a correction value (a) may be added to the arbitrary value (X). In a third step, if the value of yᵢ is changed from a positive number to a negative number or if the value of yᵢ is changed from a negative number to a positive number, a correction value (a) may become half. The clustering processing unit 130 may repeatedly perform the second step and the third step until a difference (e.g., lyᵢ₊₁−yᵢl) between values of two consecutive ys is smaller than a predetermined critical value. The critical value may be set to be 0.01, however the critical value is not limited thereto. Here, i may be a positive number and may be the number of performing the second step and the third step.

The clustering processing unit 130 may determine a value of an arbitrary value (X) obtained when a difference (e.g., lyᵢ₊₁−yᵢ) between values of two consecutive ys is smaller than a predetermined critical value and determine the value of an arbitrary value (X) as a target bandwidth. (BW_{target}). Here, i may be a positive number and may mean the number of processes of performing the second step and the third step.

The motion vector processing device 100 may use the target bandwidth (BW_{target}) to cluster the corresponding points. Outlier vectors may be removed by clustering the corresponding points in at least one cluster having a target bandwidth (BW_{target}) to generate more effective clustered motion vectors.

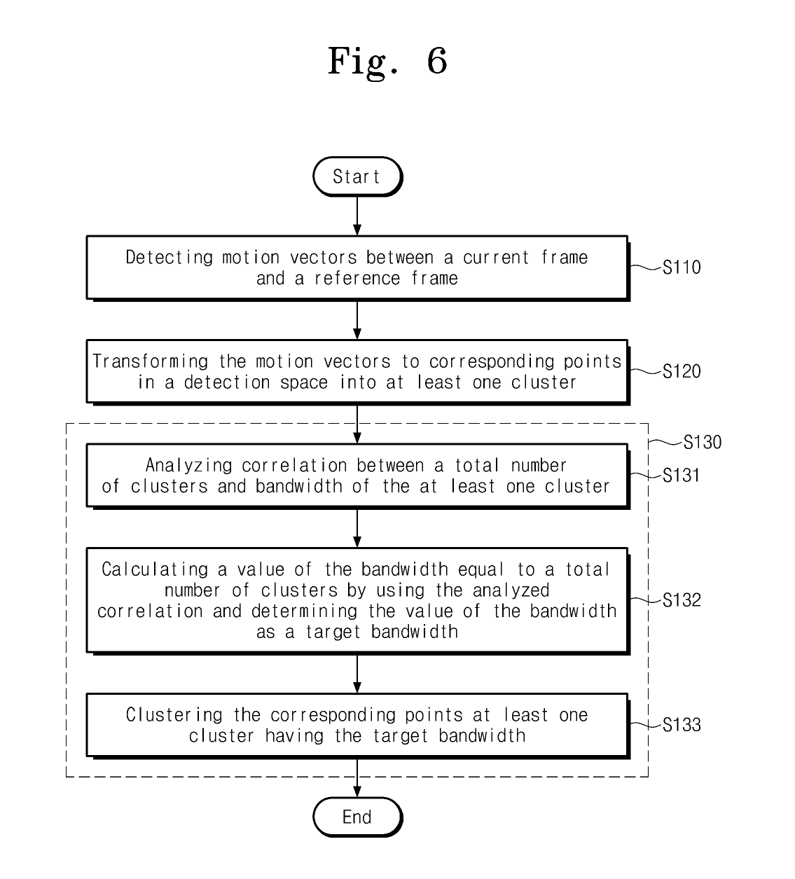

FIG. 6 is a flow chart illustrating a method of processing a motion vector in accordance with an embodiment of the present inventive concept.

Referring to FIG. 6, a method of processing a motion vector in accordance with an embodiment of the present inventive concept may include detecting motion vectors between a current image frame and a reference image frame (S110), transforming the motion vectors into corresponding points in a detection space (S120), and clustering the corresponding points in at least one cluster (S130).

In S110, the motion vector detection unit 110 may detect motion vectors between a current frame and a reference frame.

In S120, the transforming unit 120 may transform the detected motion vectors into corresponding points in a detection space into at least one cluster each having a bandwidth. The transforming unit 120 may use a prediction method such as by using a Kalman Filter to transform the detected motion vectors into the corresponding points.

The S130 may further include analyzing a correlation between a total number (Nc) of clusters of the at least one cluster and a bandwidth (BW) of each of the at least one cluster (S131), calculating a value of the bandwidth (BW) equal to a total number (Nc) of clusters of the at least one cluster, by using the analyzed correlation and determining the value of the bandwidth (BW) as a target bandwidth (BW_{target}) (S132), and clustering the corresponding points in at least one cluster having the target bandwidth (BW_{target}) (S133).

In S131, the clustering processing unit 130 may analyze a correlation between a bandwidth (BW) of each of the at least one cluster and a total number (Nc) of clusters of the at least one cluster by using the mathematical formula 1.

In S132, the clustering processing unit 130 may calculate values of b and n by using the mathematical formulas 2, 3 and 4. The clustering processing unit 130 may calculate a target bandwidth ((BW_{target})) by using mathematical formulas 5 and 6. For example, it is assumed that a value of Np is determined in advance as 100. Additionally, it is assumed that b and n are calculated as 1 and 2, respectively, by using the mathematical formulas 2, 3 and 4. A correction value (a) is assumed to be 0.5. An initial arbitrary value, denoted as X₁, for calculating a target bandwidth (BW_{target}) is assumed to be 1. Since X₁ is 1, and Np, b, n are 100, 1, 2, respectively, y₁ may be calculated to be 49.5 by using the mathematical formula 6. Since yₜ is greater than 0, X₂ may become X₁-0.5, that is, 0.5. Since X₂ is 0.5, y₂ is calculated as 79.7. Since y₂ is greater than 0, X₃ may become X₂-0.5, that is, 0. Since X₃ is 0, y₃ is calculated as 100. Since y₃ is greater than 0, X₄ may become X₃-0.5, that is, −0.5. Since X₄ is −0.5, y₄ is calculated as 79.7. Since y₄ is greater than 0, X₅ may become X₄-0.5, that is, −1.

Through repetition of the aforementioned processes, an arbitrary value (X) when a difference (e.g., lyᵢ₊₁−yᵢl) between values of two consecutive ys is smaller than the critical value 0.01 may be calculated to become the target bandwidth (BW_{target}).

In S133, the clustering processing unit 130 may cluster the corresponding points by using the determined target bandwidth (BW_{target}).

The method of processing a motion vector in accordance with an embodiment of the present inventive concept may determine a target bandwidth (BW_{target}) to cluster the corresponding points. Outlier vectors may be removed by clustering the corresponding points in at least one cluster having a target bandwidth (BW_{target}) generate more effective clustered.

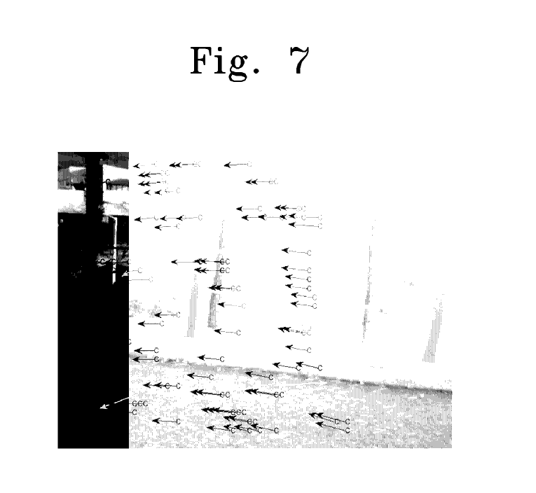

FIGS. 7 to 10 show an example in which a method of processing a motion vector in accordance with an embodiment of the present inventive concept is used.

Referring to FIG. 7, for example, a first group of the motion vectors (for example, see black motion vector arrows) having similar directions and lengths may have similar distances and directions of moving of the objects. A second group of the motion vectors (for example, see white color motion vector arrows) having different directions and lengths may have different distances and directions of moving of the objects from those from the first group of the motion vectors. Since most of the motion vectors belong to the first group of the motion vectors, the second group of the motion vectors may be regarded as outlier vectors and may be removed through a clustering process.

Referring to FIG. 8, the corresponding points transformed into a detection space are illustrated. Corresponding points (k) into which outlier vectors among motion vectors are transformed may be different from most of the other motion vectors. Thus, to cluster in a manner in which the outlier vectors are excluded, it is necessary to properly select a bandwidth (BW) of each of the at least one cluster.

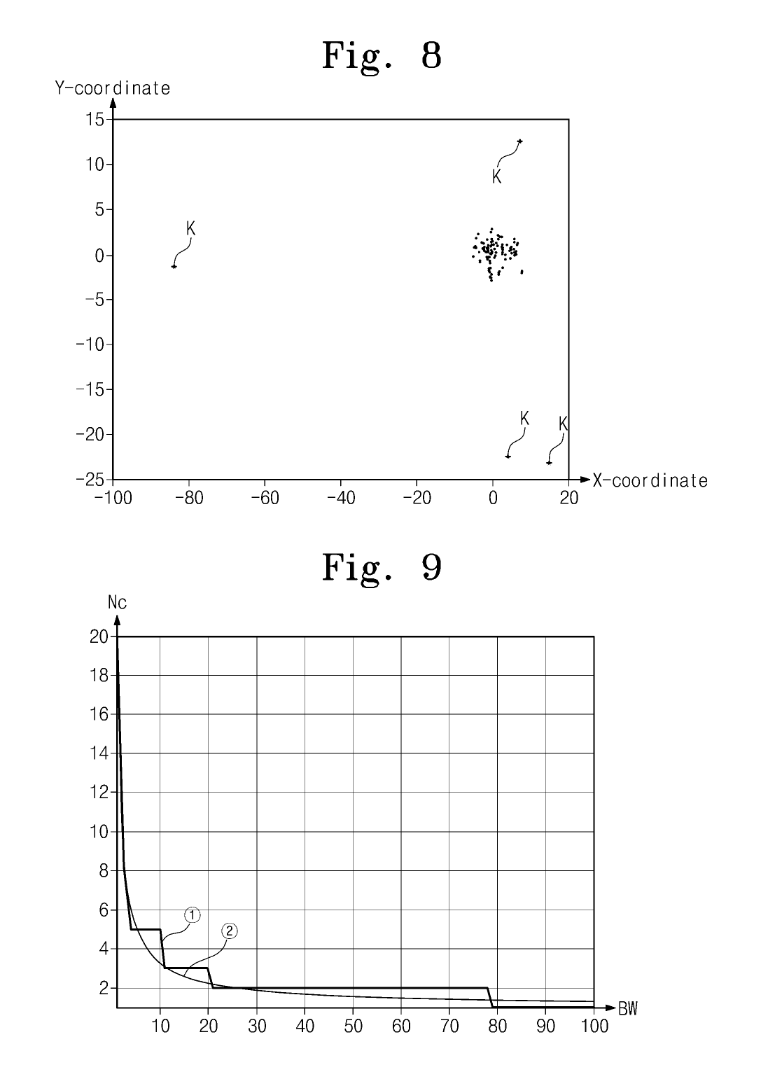

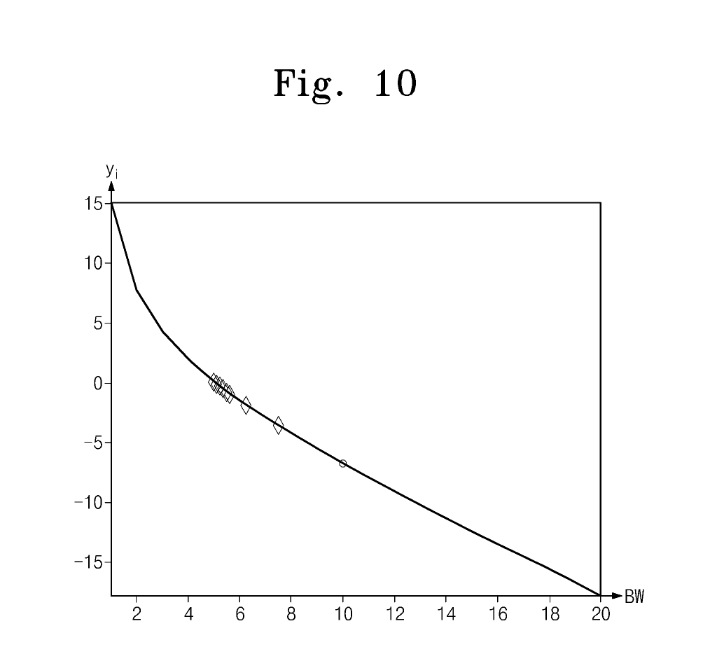

Referring to FIG. 9, a graph \textcircled{1} and \textcircled{2} show a correlation between a bandwidth (BW) of a cluster and the number (Nc) of clusters. The graph \textcircled{1} may be calculated by clustering the corresponding points based on the Mean-Shift algorithm. The graph \textcircled{2} may be calculated by using the mathematical formula 1. The clustering processing unit 130 may use a Linear Least Squares to fit the graph \textcircled{2}, to the graph \textcircled{1}. The clustering processing unit 130 may calculate values of b and n by using the mathematical formulas 2, 3 and 4.

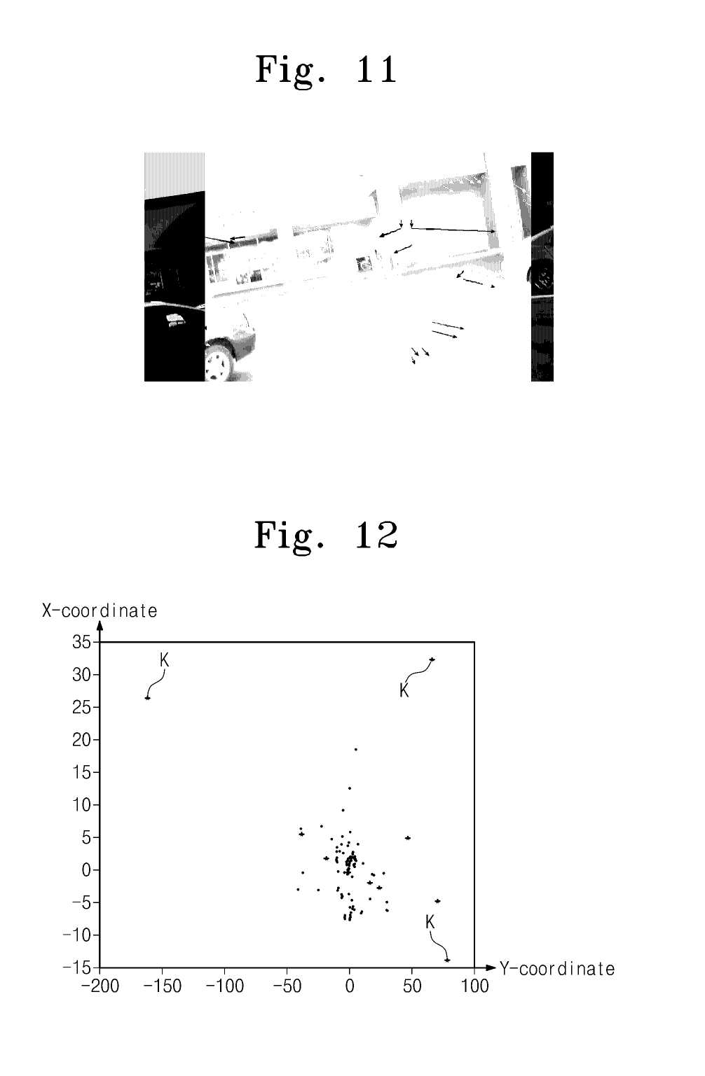

Referring to FIG. 10, a difference between values of two consecutive ys may converge to a value smaller than a predetermined critical value (e.g., 0.01). A value of bandwidth (BW) obtained when the difference between values of two consecutive ys becomes smaller than the critical value may be determined as a target bandwidth (BW_{target}).

FIGS. 11 to 14 show an example in which a method of processing a motion vector in accordance with an embodiment of the present inventive concept is used.

Referring to FIG. 11, motion vectors detected by a motion vector detection unit of FIG. 1 are illustrated. Unlike FIG. 7, outlier vectors are illustrated as black colored arrows.

Referring to FIG. 12, the corresponding points of motion vectors may look more scattered than those of FIG. 8, but corresponding points (k) of the outlier vectors may be different from the motion vectors clustered together.

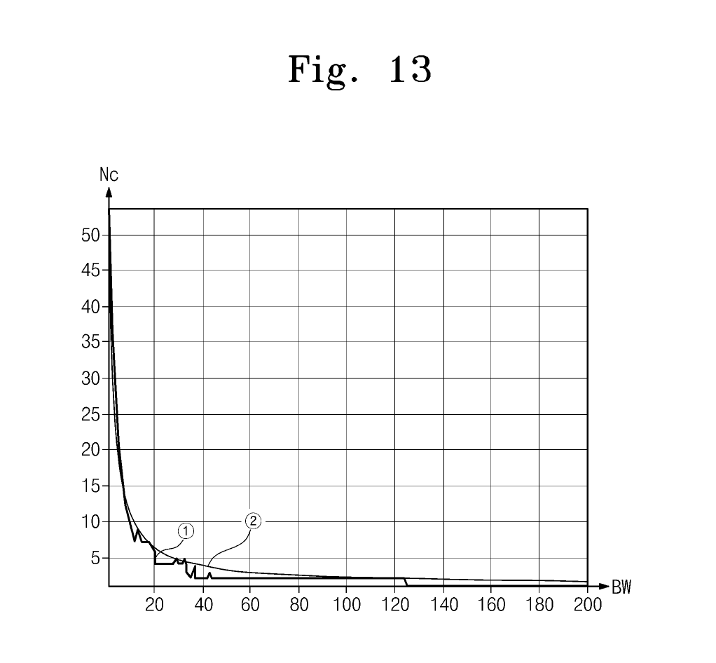

Referring to FIG. 13, a graph \textcircled{1} and \textcircled{2} show a correlation between a bandwidth (BW) of a cluster and the number (Nc) of clusters. The graph \textcircled{1} may be calculated by clustering the corresponding points based on the Mean-Shift algorithm. The graph \textcircled{2} may be calculated by using the mathematical formula 1. The clustering processing unit 130 may use a Linear Least Squares to fit the graph \textcircled{2} to the graph. The clustering processing unit 130 may calculate values of b and n by using the mathematical formulas 2, 3 and 4.

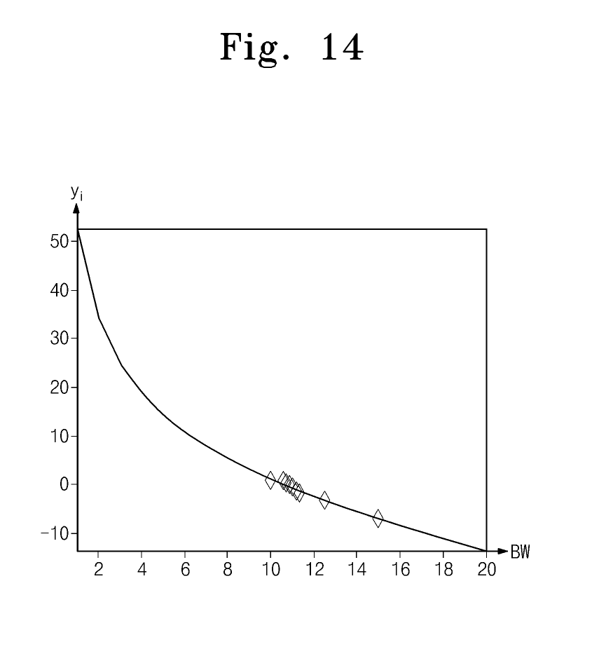

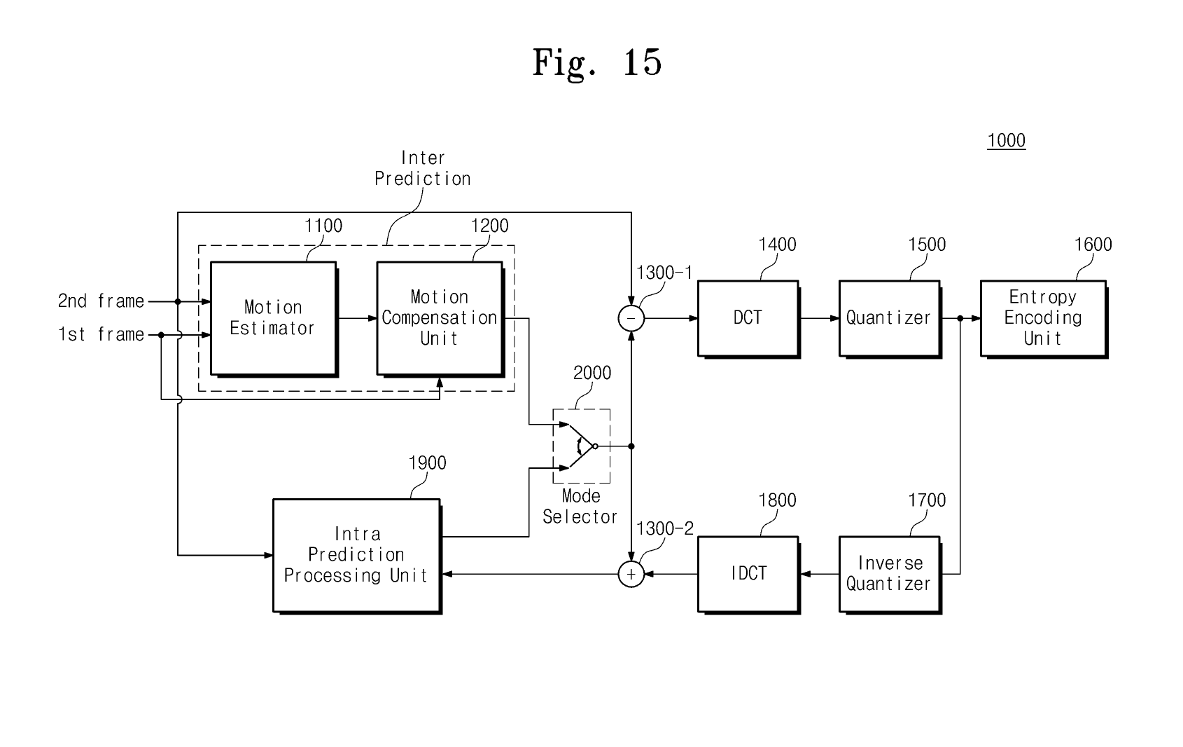

Referring to FIG. 14, a value of a bandwidth (BW) obtained when a difference between values of two consecutive ys becomes smaller than a critical value may be determined as a target bandwidth (BW_{target}).

FIG. 15 is a block diagram illustrating a video encoding device in accordance with an embodiment of the present inventive concept.

Referring to FIG. 15, a video encoding device 1000 in accordance with an embodiment of the present inventive concept may include a motion estimator 1100, a motion compensation unit 1200, an subtractor 1300-1, an adder 1300-2, a discrete cosine transforming (DCT) unit 1400, a quantizer 1500, an entropy encoding unit 1600, an inverse quantizer 1700, an inverse discrete cosine transforming (IDCT) unit 1800, an intra prediction processing unit 1900, and a mode selector 2000.

The video encoding device 1000 may operate in an inter prediction mode or an intra prediction mode according to a control of a mode selector 2000.

The motion estimator 1100 may receive a first frame (e.g., a reference image frame) stored in an internal memory and a second frame (e.g., a current image frame) shot by an image sensor (not shown). The motion estimator 1100 may designate a specific macro block and may estimate a motion vector relative to the designated macro block. The motion estimator 1100 may include the motion vector processing device 100 illustrated in FIG. 1. The motion estimator 1100 may detect motion vectors and may cluster the detected motion vectors.

The motion compensation unit 1200 may perform motion compensation on the first frame by using motion vectors that may be transferred from the motion estimator 1100, and transfer the motion compensated frame to the subtractor 1300-1.

The subtractor 1300-1 may receive the motion compensated frame and the second frame to generate a differential frame between the motion compensated frame and the second frame.

The DCT unit 1400 may perform a discrete cosine transformation to the differential frame to generate a DCT coefficient, and transfer the generated DCT coefficient to the quantizer 1500.

The quantizer 1500 may quantize the DCT coefficient transferred from the DCT 1400 and transfer to the entropy encoding unit 1600 and the inverse quantizer 1700.

The entropy encoding unit 1600 may encode the quantized DCT coefficient to generate an encoded output bit stream. The entropy encoding unit 1600 may use an arithmetic coding, a variable length coding, a Huffman coding, or the like to generate the encoded output bit stream.

The inverse quantizer 1700 may perform an inverse quantization for the quantized DCT coefficient.

The IDCT 1800 unit may perform an inverse discrete cosine transformation for the inversely quantized DCT coefficient that may be transferred from the inverse quantizer 1700, and transfer the inversely discrete cosine transformed DCT coefficient to the intra prediction processing unit 1900 through the adder 2000.

The intra prediction processing unit 1900 may receive the second frame and the inversely discrete cosine transformed DCT coefficient, and generate an output frame. The output frame from the intra prediction processing unit 1900 need not include a motion compensation unlike an inter prediction unit including the motion estimator 1100 and the motion compensation unit 1200.

The adder 1300-2 may receive the output frame of the intra prediction processing unit and generate an added result of the output of the intra prediction processing unit and the output of the inverse discrete cosine transforming unit. The added output of the adder 1300-2 may be an input to the intra prediction processing unit.

n. While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A motion vector processing device comprising:
a motion vector detection unit configured to detect motion vectors from a current image frame and a reference image frame;
a transforming unit configured to transform the detected motion vectors into corresponding points in a detection space; and
a clustering processing unit configured to cluster the corresponding points into at least one cluster each having a bandwidth, and to analyze a relation between the bandwidth of each of the at least one cluster and a total number of clusters of the at least one cluster.

2. The motion vector processing device of claim 1, wherein the clustering processing unit is further configured to calculate, by using the analyzed relation, a value of the bandwidth equal to a total number of clusters of the at least one cluster, to determine the value of the bandwidth as a target bandwidth, and to cluster the corresponding points by using the target bandwidth.

3. The motion vector processing device of claim 1, wherein the transforming unit uses a Kalman filter.

4. The motion vector processing device of claim 1, wherein the detection space has at least two dimensions.

5. The motion vector processing device of claim 1, wherein the clustering processing unit uses a Mean-Shift algorithm.

6. The motion vector processing device of claim 1, wherein the cluster has a circular shape.

7. The motion vector processing device of claim 1, wherein the clustering processing unit uses a mathematical formula, Nc=(Np−1)/{(b·BW)ⁿ+1}+1, to analyze the relation, wherein BW is the bandwidth of each of the at least one cluster, Nc is the total number of clusters of the at least one cluster, Np is a total number of clustered corresponding points, and b, n represent arbitrary real numbers.

8. The motion vector processing device of claim 1, wherein the clustering processing unit uses a Linear Least Square to analyze the relation.

9. A method of processing a motion vector comprising:
detecting motion vectors from a current image frame and a reference image frame;
transforming the detected motion vectors into corresponding points in a detection space;
analyzing a relation between bandwidth of each of at least one cluster and a total number of clusters of the at least one cluster;
calculating a value of the bandwidth equal to a total number of clusters by using the analyzed relation and determining the value of the bandwidth as a target bandwidth; and
clustering the corresponding points into at least one cluster having the target bandwidth.

10. The method of claim 9, wherein the step of transforming the detected motion vectors into corresponding points in a detection space is performed by using a prediction method such as a Kalman filter.

11. The method of claim 9, wherein the detection space has at least two dimensions.

12. The method of claim 9, wherein the step of clustering the corresponding points in at least one cluster is performed by using a Mean-Shift algorithm.

13. The method of claim 9, wherein the cluster has a circular shape.

14. The method of claim 9, wherein the step of analyzing the relation is performed by a mathematical formula, Nc=(Np−1)/{(b·BW)ⁿ+1}+1, wherein BW is the bandwidth of each of the at least one cluster, Nc is a total number of clusters of the at least one cluster, Np is a total number of clustered corresponding points, and b, n represent arbitrary real numbers.

15. The method of claim 9, wherein the step of analyzing the relation is performed by using a Linear Least Squares estimation.

16. A video encoding device comprising:
a motion estimator configured to receive a reference frame and a current frame, to detect motion vectors, and to cluster the detected motion vectors; and
a motion compensation unit configured to perform a motion compensation on the reference frame by using the motion vectors transferred from the motion estimator,
wherein the motion estimator comprises:
a motion vector detection unit configured to detect motion vectors from a current image frame and a reference image frame;
a transforming unit configured to transform the detected motion vectors into corresponding points in a detection space; and
a clustering processing unit configured to cluster the corresponding points into at least one cluster each having a bandwidth, and to analyze a relation between the bandwidth of each of the at least one cluster and a total number of clusters of the at least one cluster.

17. The video encoding device of claim 16, wherein the clustering processing unit is further configured to calculate, by using the analyzed relation, a value of the bandwidth equal to a total number of clusters of the at least one cluster, to determine the value of the bandwidth as a target bandwidth, and to cluster the corresponding points by using the target bandwidth.

18. The video encoding device of claim 16, further comprising:
a mode selector configured to select a mode for operating the vide encoding device between an inter prediction mode and an intra prediction mode;
a subtractor configured to receive the output of the motion compensation unit and the current frame, and to generate a differential frame between the output of the motion compensation unit and the current frame;
a discrete cosine transforming unit configured to perform a discrete cosine transformation to the differential frame and to generate a discrete cosine transforming coefficient; and
a quantizer configured to quantize the discrete cosine transforming coefficient.

19. The video encoding device of claim 18, further comprising:
an entropy encoding unit configured to encode the quantized discrete cosine transforming coefficient and to generate an encoded output;
an inverse quantizer configured to perform an inverse quantization for the output of the quantizer; and
an inverse discrete cosine transforming unit configured to perform an inverse discrete cosine transformation for the output of the inverse quantizer.

20. The video encoding device of claim 19, further comprising:
an intra prediction processing unit configured to receive the output of the inverse discrete cosine transforming unit through an adder and the current frame, and to generate an output;
an adder configured to receive the output of the intra prediction processing unit, and to provide an added result of the output of the intra prediction processing unit and the output of the inverse discrete cosine transforming unit as an input to the intra prediction processing unit.
